(19) United States
(12) Patent Application Publication
(10) Pub. No.: US 2012/0141344 A1
(43) Pub. Date: Jun. 7, 2012

(54) Flow-Through Structure with Active Ingredients

(75) Inventors: Naresh Mahamuni, Nevada City, CA (US); Peter L. Nelson, Grass Valley, CA (US)

(73) Assignee: IMPULSE DEVICES INC., Grass Valley, CA (US)

(21) Appl. No.: 13/313,324

(22) Filed: Dec. 7, 2011

Related U.S. Application Data
(60) Provisional application No. 61/420,357, filed on Dec. 7, 2010.

(51) Int. Cl. B01D 53/94; B01J 37/34

(52) U.S. Cl. 423/212; 502/5

(57) ABSTRACT

The present disclosure describes systems and methods for making an active bed for use in catalyst, filter or other chemical processing systems. A fluidic substrate material is combined with one or more active ingredients while in the fluid or substantially plasticized state. Acoustic energy is applied to the fluidic substrate and active ingredient mixture, and static pressure is applied as well. The pressure is released and the mixture is allowed to form porous fluid-permeable structures (sometimes a lattice) through which a fluid to be processed can be passed.

### RELATED APPLICATIONS

The present application is related to and claims the benefit and priority of Provisional Application No. 61/420,357, bearing the same title, filed on Dec. 7, 2010, which is hereby incorporated by reference.

### TECHNICAL FIELD

The present disclosure relates to the inclusion of active ingredients in lattice structures formed by application of acoustic energy to a substance capable of forming the same, and specifically to systems and methods for making and using the present reactive acoustic lattice structures, and to methods employing the present reactive acoustic lattice structures.

### BACKGROUND

It is known that certain reactions can be accelerated or enhanced in the presence of a catalyst or catalytic material. That is, a favorable (increased) change in the rate of a desired chemical reaction can be obtained by using a catalyst. Chemical and mechanical-chemical processes may be encouraged or facilitated or enhanced through passing a given reactant or substance through a structure that includes in or on it the catalyst substance. Both reduction and oxidation reactions can be encouraged by proper use of a catalyst in treating exhaust and other industrial emissions.

In some areas of manufacturing (e.g., in the automotive industry) a catalytic converter is used to reduce unwanted emissions from the exhaust of internal combustion engines. A catalytic converter chemically acts on one or some byproducts of the internal combustion process to capture the same or to exchange these byproducts for less toxic products that are released into the environment. The use of catalytic converters to scrub or act on the exhaust of engines is partly driven by a general desire to minimize the environmental impact of internal combustion engines, and also to satisfy ever-stricter regulatory guidelines and laws governing allowable emission levels.

Typically, it is desired to increase the available surface area of a catalytic converter so that it provides as much area for reaction between the catalyst material and the exhaust byproducts as possible. To this end, the catalyst substance itself is applied to a labyrinthine core structure (e.g., a honeycomb structure) to increase the overall surface area of the converter. Even further, a washcoat surface of silica or alumina is sometimes applied to the core structure to give the converter an even greater amount of surface area at a microscopic scale. The catalyst substance in catalytic converters used for internal combustion engine exhaust processing can comprise palladium, platinum, and rhodium.

It has remained a challenge to design and manufacture effective catalyst beds and catalytic structures that act on a substance flowing therethrough.

### SUMMARY

The present disclosure describes systems and methods for making an active bed for use in catalyst, filter or other chemical processing systems. A fluidic substrate material is combined with one or more active ingredients while in the fluid or substantially plasticized state. Acoustic energy is applied to the fluidic substrate and active ingredient mixture, and static pressure is applied as well. The pressure is released and the mixture is allowed to form porous fluid-permeable structures (sometimes a lattice) through which a fluid to be processed can be passed.

Some embodiments are directed to a method for making a catalytic structure, comprising providing a bulk material in substantially fluidized form; mixing a catalyst substance into said fluidized bulk material; placing a mixture of said catalyst substance and said fluidized bulk material into an acoustic chamber; applying an acoustic field to said mixture in said acoustic chamber so that said mixture is variable corresponding to a spatial configuration of said acoustic field; and solidifying said mixture so as to retain a spatial variability corresponding to said spatial configuration of said applied acoustic field.

Other embodiments are directed to method for processing a process fluid in a catalytic structure, comprising mixing a bulk material and a catalyst material; placing a mixture of said bulk and catalyst materials into an acoustic chamber; applying an acoustic field to said mixture so as to form voids therein corresponding to a spatial variability of said acoustic field within said chamber; solidifying said mixture so as to retain said voids in a solid structure containing said voids; and introducing said process fluid into said solid structure containing said voids at a fluid pressure so as to cause flow of said process fluid from a first portion of said structure towards a second portion of said structure.

### BRIEF DESCRIPTION OF THE DRAWINGS

For a fuller understanding of the nature and advantages of the present concepts, reference is be made to the following detailed description of preferred embodiments and in connection with the accompanying drawings, in which:

FIG. 1 illustrates an exemplary acoustic resonator used to form an active fluid processing structure according to the present disclosure;

FIG. 2 illustrates an exemplary acoustic field lattice formed in a hypothetical chamber;

FIG. 3 illustrates an exemplary mechanical construction for a spherical resonator that may be used to make active fluid processing structures therein;

FIG. 4 illustrates an exemplary appearance of a solidified substrate material with pockets, voids or cavities formed therein as would be derived from a spherical chamber; and

FIG. 5 illustrates the use of a perforated active flow-through structure in a catalyst or reactor apparatus.

### DETAILED DESCRIPTION

As discussed above, it is useful to have efficient catalyst devices to enhance or accelerate or increase a desired reaction. A Catalyst apparatus is generally designed to allow flow of a fluid past a large surface area of the catalyst apparatus so as to achieve a maximum or a desired level of activity between the flowing fluid and the catalyst material. The present disclosure provides methods and systems for making such catalyst structures as would be effective and efficient for processing various fluids.

In some embodiments, a catalyst structure is formed by placement of a fluidic or fluidized plastic or polymeric substrate substance into an acoustic chamber so that the substrate substance is at least substantially flowable. For example, this may be done by using a polymer that is heated to a temperature where it can substantially flow (e.g., above its melting point). A catalytic (or generally an active ingredient or reactive agent) is added to the substrate substance to be mixed therein. Acoustic drivers, such as piezoelectric transducers (PZTs), coupled to the acoustic chamber are driven to cause an acoustic field within the chamber. The acoustic field in the chamber causes macroscopic and microscopic movement of the fluidic substrate and mixing of the reactive agent or catalyst material with the fluidic substrate. Mixing may be enhanced by acoustic cavitation (bubbles formed or driven by the acoustic drivers) or by acoustic streaming in the bulk of the fluidic substrate, especially in the vicinity of any inclusions such as the catalyst material.

Once the acoustic field has been applied to the contents of the chamber, the active ingredient or catalyst material becomes mixed, distributed or dissolved in the bulk of the fluidic substrate. This process may be enhanced by driving the acoustic drivers so as to cause cavitation within the contents of the chamber. The violent activity from the formation, movement and collapse of the cavitation bubbles further mixes the contents of the chamber and causes small scale and macroscopic streaming of the contents.

After the active ingredient(s) and the fluidic substrate material are sufficiently mixed, the chamber may be depressurized or the static pressure therein reduced. Also, the chamber or its contents may be cooled. This causes the fluidic substrate to become substantially solidified. This also causes numerous voids or pockets to form in the substrate material, which can resemble Swiss cheese, a sponge, or an organized or disorganized lattice structure. However, the active ingredient(s) or catalyst material(s) are now dispersed throughout the substrate, including on or around the numerous voids in the substrate.

In some embodiments, a catalytic converter is formed having a substrate material (e.g., plastic) that includes a desired amount of active ingredient (e.g., catalyst material) and has a porous structure that permits flow of a fluid (e.g., a liquid or a gas) through the voids in the structure. Some embodiments take advantage of the regularity of an applied acoustic field to give a corresponding regular set of voids in the structure like a traditional lattice. Other embodiments have substantially arbitrary or random void placement in the structure.

Once formed, the structure is now ready for inclusion in or use in a catalyst apparatus or an active filter or another such flow-through apparatus to process a flowing fluid that interacts with or reacts with the active ingredient of the apparatus. This flowing fluid may be introduced into the apparatus under pressure, such as by a pump or under the force of gravity. The fluid may also be pre-processed using any number and type of steps, such as by heating or cooling the fluid to a determined temperature. Also, the fluid may be chemically pre-processed before introducing it into the apparatus. Likewise, the fluid may be post-processed after it comes out of the catalyst portion of the apparatus.

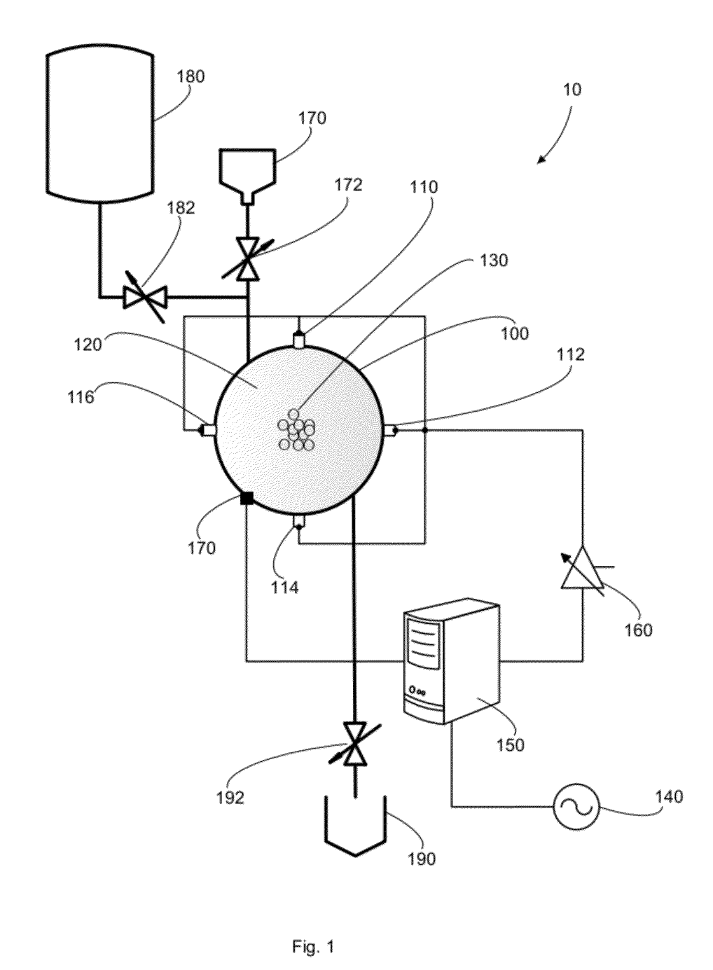

FIG. 1 illustrates an exemplary system 10 for making a catalytic structure according to the present concepts. An acoustic resonator chamber 100 is provided, which is preferably made of a solid material and having solid walls such as metal walls, and more specifically, such as stainless steel walls in some embodiments. The resonator has fluid inlets and outlets for filling and discharging a fluid substance 120.

Acoustic activity by one or more acoustic drivers (e.g., 110, 112, 114, 116) coupled to chamber 100 create an acoustic field within chamber 100. As mentioned before, the fluid in chamber 100 may be placed under static pressure by a pressure source such as a pump. The drivers may further cause acoustic cavitation 130 in at least a portion of the volume within chamber 100. The drivers are mechanically fixed to an outside surface of chamber 100 in some embodiments, such as by welding, epoxy fixing, or threading into corresponding mating places on the outside walls of chamber 100. The drivers deliver oscillatory or vibratory or translational movement at a driving frequency in a typical embodiment. The driving signal may originate in an oscillator 140, optionally being computer controlled by a computer 150 and amplified by an amplifier 160 to a desired amplitude. The plurality of drivers may all be driven in unison by a single driving signal or may be connected to separate driving signals and sources and driven individually as needed. A sensor 170 may sense some parameter and send an output signal to computer 150 indicative of the sensed parameter. The sensor 170 may sense pressure within chamber 100, temperature in chamber 100, or an acoustic field or signal from chamber 100. A feedback circuit may be provided in computer 150 to control the driving signal(s) to the acoustic drivers responsive to a sensed signal measured by sensor 170.

Fluid (e.g., distilled water) may be provided from a source 180, which can be controlled by a shutoff or throttle valve 182. An active ingredient, chemical agent, catalyst material or other substance may be provided from a source 170, which may be coupled to the input fluid source by a valve 172. Premixing of the fluid and the active agent or chemical may take place prior to delivery of the same to chamber 100, but these ingredients may also be mixed inside chamber 100 as described earlier. For example, the mixing can be carried out in the presence of an acoustic field or a cavitation field in chamber 100.

A drain port is provided to discharge or drain the fluid contents 120 from chamber 100 through a drain valve 192 into a receiver 190. The fluid portion of the system 10 may be used to pressurize and depressurize the contents of chamber 100. The chamber 100 may be designed to be opened up, for example by making it from two half spherical shell portions that can be locked together when closed and then opened up to retrieve something from inside the spherical shell.

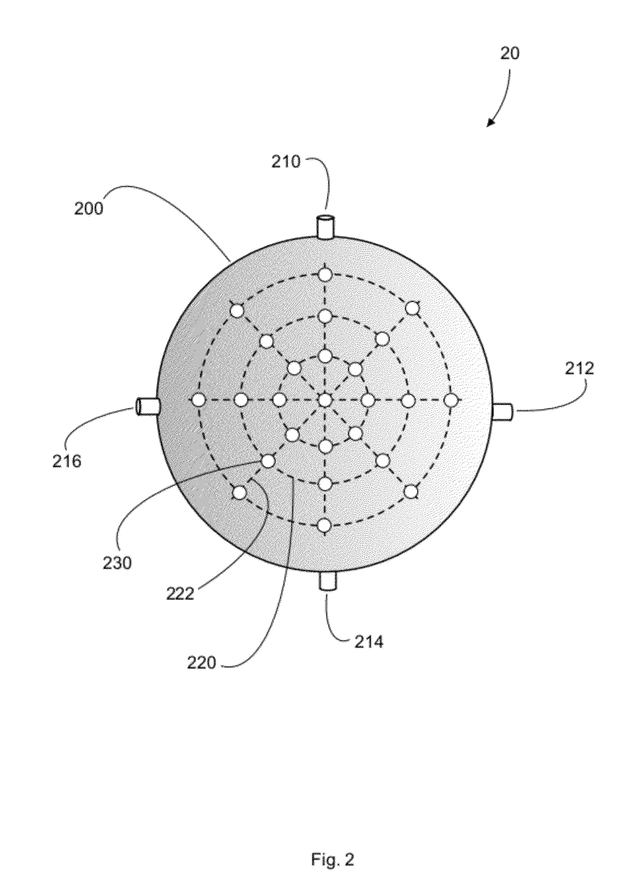

FIG. 2 illustrates an exemplary cross-section of a spherical acoustic chamber (or a cross-section of a cylindrical chamber as well). The chamber 200 has solid (e.g., metal) walls. Acoustic drivers 210, 212, 214 and 216 provide acoustical energy that is coupled to the fluid contents of the chamber.

An acoustical field may be set up, indicated by the dashed lines in the drawing, which are neither intended to be to scale or representative of any specific mode. Certain locations within the volume enclosed by chamber 200 walls may develop especially low (or high) acoustic pressures due to the applied acoustic field therein. For example, as shown by way of conceptual illustration, a series of radial and longitudinal acoustic field lines 220, 222 may intersect at the locations 230 indicated by the white circles. These special locations (which don't need to be point-like but can be two or three-dimensional) can cause a fluidic substrate in chamber 200 to experience special effects so as to cause localized voids at locations 230. If the fluidic substrate material is then solidified, the places 230 where the acoustic field in chamber 200 has the given properties would appear as channels that a fluid may be flowed in.

As said earlier, an active ingredient, chemical, reactive substance, catalyst material, etc. may be introduced into the fluidic substance before it is solidified and mixed therewith. Once solidified, the porous or lattice-like void structure becomes the basis for the active (catalytic) structure through which a process fluid can be passed.

It should be understood that more than one such apparatus can be assembled into a larger processing system. For example, two or more such active catalysts may be placed in series, with the inlet of one receiving flowing fluid from the discharge of an upstream apparatus. In this way the flowing fluid may be acted on by the agents or catalysts in the apparatuses collectively and more thoroughly. Alternatively, increased volumetric flow rates may be achieved by placing a plurality of such apparatuses in parallel so that a feed fluid can enter into each of the plurality substantially in parallel. A common inlet and/or outlet plenum may be designed to hold the incoming and/or processed fluid respectively.

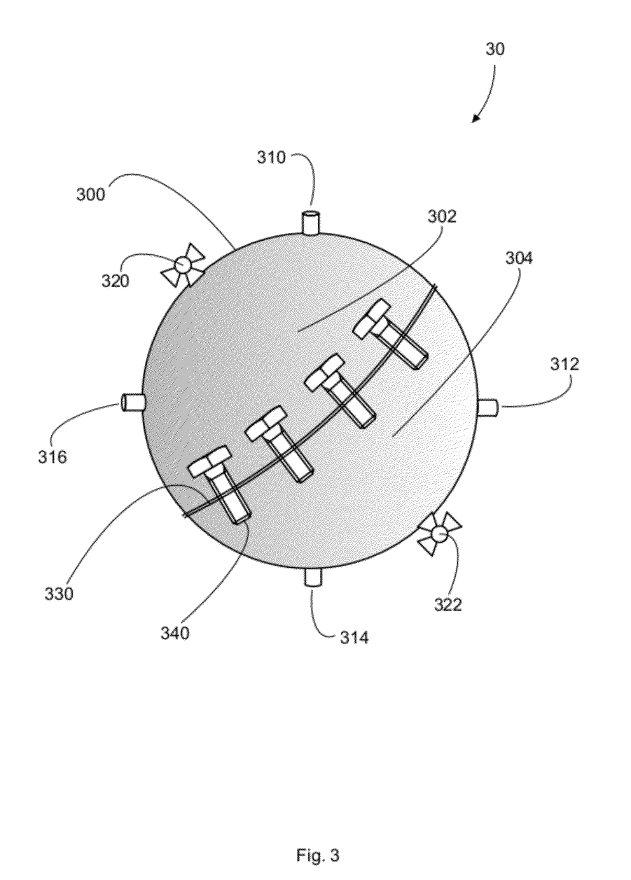

FIG. 3 illustrates an exemplary mechanical assembly 30 in which the present processing and making of the active porous structures may be accomplished according to some embodiments. A solid (e.g., metal, steel) spherical shell 200 comprises two parts 302 and 304. In some embodiments, the two parts 302, 304 may be substantially two hemispherical halves of spherical resonator chamber 300. The two parts 302 and 304 of resonator 300 may be coupled to one another during operation by a pressure-tight seal 330, which may comprise a flange, O-ring, or other press-fit or threaded or keyed interlocking members so that the parts 302 and 304 stay firmly in place during operation with a fluid in resonator 300. A set of mechanical fasteners (e.g., hex bolts, rivets, clamps, etc.) 340 may be used to secure the parts 302, 304 to one another, and are only shown by way of illustration. The present disclosure is not limited to embodiments having two half-spherical parts, and resonator chamber 300 may be shaped in non-spherical forms and may include more than two parts thereof. Once the fluidic substrate and active ingredient materials in resonator 300 are treated as needed to suit a given situation (e.g., using ultrasound sonication, static pressure, cavitation, heating, chemical treatment) the contents may be depressurized to cause many small voids, cavities, or bubbles to form in the body of the bulk material inside resonator 300. This may be cooled to solidify the contents, after which the solidified contents may be removed from resonator chamber 300 by opening it up and removing said solidified contents. For example, hex bolts 340 are loosened and the two halves 302, 304 of the spherical resonator are separated apart to reveal the solidified porous active fluid processing structure within. The resulting structure can then be cut or machined as described below for inclusion in a catalyst apparatus or filtration system.

An inlet valve or port 320 allows for taking in a fluid into acoustic resonator chamber 300, and an outlet valve or port 322 allows for discharge of a fluid from the resonator chamber. The valves 320, 322 may also be used to pressurize and depressurize the interior volume of resonator 300. In addition, other substances may be introduced into the resonator 300 through the fluid ports 320, 322, or other points of access.

As said before, one or more acoustic drivers may be fixed to respective points on the surface of resonator chamber 300. For example PZT driver elements 310, 312, 314, 316 may be placed at regular intervals on the surface of the resonator shell so as to cause an acoustic field within the resonator of a desired strength and configuration. The acoustic drivers may be placed on the resonator 300 as described in other issued and pending patents to the present assignee, which are hereby incorporated by reference. The placement of the acoustic drivers may take into consideration the relative location of acoustic field maxima and may account for flexural, breathing, and surface modes that can arise in the shell or structures of apparatus 30.

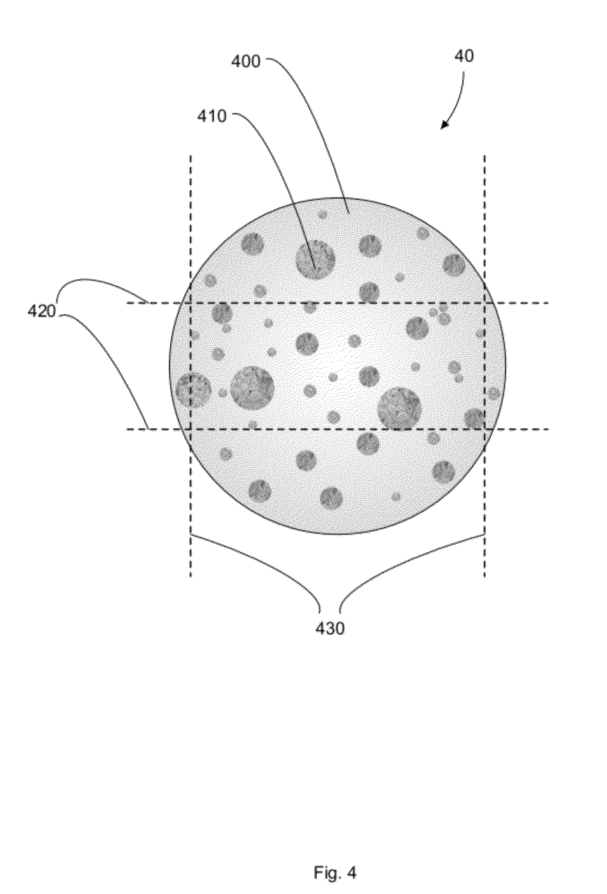

FIG. 4 illustrates an exemplary solidified porous structure 40, which may be similar to that pulled out of the apparatus described above once its contents have solidified. In this example a substantially spherical solidified structure 400 includes many voids, bubbles, or other formations 410 that result from depressurizing the contents of the acoustic chamber discussed above. The voids provide a generally porous structure because they are internally inter-connected so that a fluid can then be passed through the structure.

In some embodiments, substantially randomly sized and positioned voids 410 are formed in the structure. In other embodiments, more regular sized or regularly spaced voids are formed, for example, if the formation of the voids is encouraged by an acoustic field applied to the fluidized substrate material as it is solidified. A lattice structure can be formed, e.g. a honey comb structure, in some embodiments.

Once a bulk solidified and activated (permeated with the active ingredient) structure 410 is made, it can be machined or otherwise cut to size or reshaped as needed for use in a catalyst, filter or other apparatus. Here, a set of horizontal cuts 420 and a set of vertical cuts 430 are made (similar to cutting cheese in some embodiments) to obtain a usefully-shaped active structure.

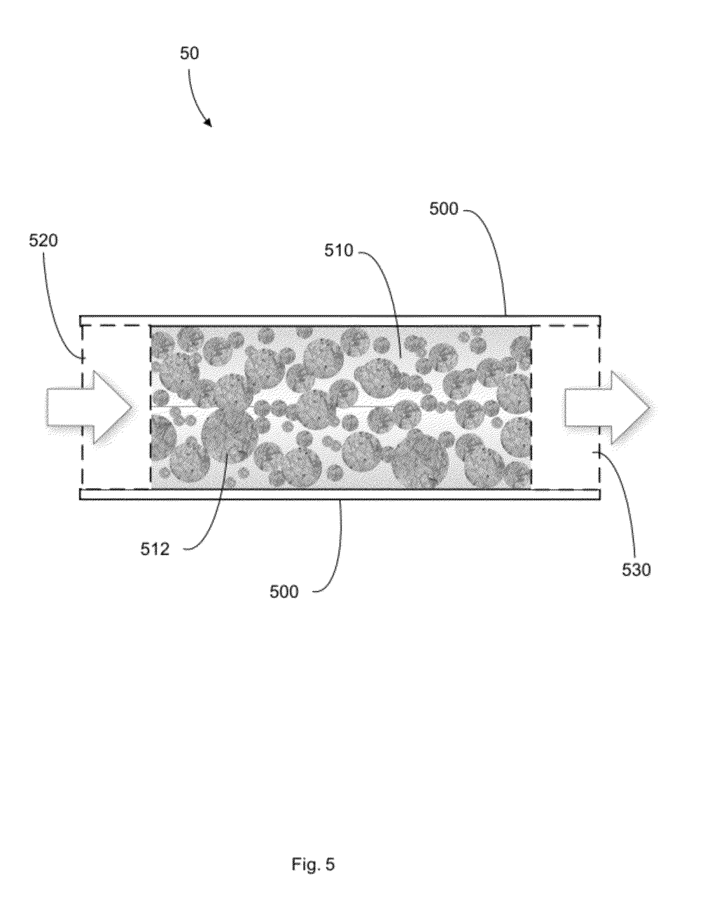

FIG. 5 illustrates a catalyst or active filter apparatus 50. The catalyst comprises a solid shell wall 500 which may be a stainless steel cylindrical tube of certain diameter and length, or may be a rectangular cross-section in other examples. The activated and solidified porous structure described above is placed into a central place in the apparatus 50. For example a cylindrical slug including the solidified substrate 510 and voids or inclusions 512 are used as the catalyst or filter bed material. An inlet plenum 520 allows a fluid intended for processing to be introduced into the apparatus 50. An outlet plenum 530 delivers the fluid out of the apparatus 50.

Note that other auxiliaries may be incorporated into the catalytic converter or active filter apparatus 50. For example, a heating or cooling coil, a pressure or temperature control system, further acoustic or ultrasonic drivers, and other auxiliary elements can be included in the design.

The present inventions should not be considered limited to the particular embodiments described above, but rather should be understood to cover all aspects of the invention as fairly set out and made apparent to those of ordinary skill by the present disclosure. Various modifications, equivalent processes, as well as numerous structures to which the present invention may be applicable, will be readily apparent to those skilled in the art to which the present invention is directed upon review of the present disclosure.

What is claimed is:

1. A method for making a catalytic structure, comprising:
providing a bulk material in substantially fluidized form;
mixing a catalyst substance into said fluidized bulk material;
placing a mixture of said catalyst substance and said fluidized bulk material into an acoustic chamber;
applying an acoustic field to said mixture in said acoustic chamber so that said mixture is variable corresponding to a spatial configuration of said acoustic field; and
solidifying said mixture so as to retain a spatial variability corresponding to said spatial configuration of said applied acoustic field.

2. The method of claim 1, said providing of a bulk material in substantially fluidized form comprising heating a solid bulk material to a temperature where said bulk material becomes substantially fluidic.

3. The method of claim 2, said heating including raising a temperature of said bulk material to a level substantially at or exceeding its melting temperature.

4. The method of claim 1, further comprising cooling said mixture so as to solidify it.

5. The method of claim 1, applying said acoustic field and solidifying said mixture comprising forming voids corresponding to the spatial configuration of said acoustic field.

6. The method of claim 1, further comprising causing acoustic cavitation within said fluidized mixture so as to cause porous pockets to form therein.

7. The method of claim 1, further comprising treating said mixture at a first static pressure during a first phase of treating the same and then applying a second static pressure to the mixture during a second phase of treating the same.

8. A method for processing a process fluid in a catalytic structure, comprising:
mixing a bulk material and a catalyst material;
placing a mixture of said bulk and catalyst materials into an acoustic chamber;
applying an acoustic field to said mixture so as to form voids therein corresponding to a spatial variability of said acoustic field within said chamber;
solidifying said mixture so as to retain said voids in a solid structure containing said voids; and
introducing said process fluid into said solid structure containing said voids at a fluid pressure so as to cause flow of said process fluid from a first portion of said structure towards a second portion of said structure.

9. The method of claim 8, further comprising controlling said flow so that said process fluid makes sufficient contact with said catalyst material in said solid structure to achieve a desired catalytic reaction between said process fluid and said catalyst material.

10. The method of claim 8, further comprising placing a plurality of such catalytic structures in parallel with one another in a fluid circuit to process said process fluid in parallel within each of said plurality of catalytic structures.

11. The method of claim 8, further comprising placing a plurality of such catalytic structures in series with one another in a fluid circuit to process said process fluid sequentially in said plurality of catalytic structures.

12. The method of claim 11, further providing each of said plurality of catalytic structures with a different type of catalytic material.
